(19) United States
(12) Patent Application Publication
(10) Pub. No.: US 2016/0144759 A1
(43) Pub. Date: May 26, 2016

(54) TAILGATE RAMP APPARATUS

(71) Applicant: Magna Closures Inc., Newmarket (CA)

(72) Inventors: Dominic DiBLASIO, Queensville (CA); Kurt Matthew SCHATZ, Uxbridge (CA)

(21) Appl. No.: 14/948,456

(22) Filed: Nov. 23, 2015

Related U.S. Application Data
(60) Provisional application No. 62/083,363, filed on Nov. 24, 2014.

(51) Int. Cl. B60P 1/43; B65G 69/30; B62D 33/08

(52) U.S. Cl. CPC B60P 1/435; B60P 1/433; B62D 33/08; B65G 69/30

(57) ABSTRACT

A tailgate assembly for providing access to a cargo bed of an automotive vehicle. The tailgate assembly includes a tailgate and a ramp assembly having a casing and a multi-panel ramp unit. The ramp unit includes a plurality of panels that extend in telescoping relationship with one another and are slideably moveable between a collapsed position with the panels in overlying relationship with one another inside the tailgate, and a lengthened position with the panels extending in generally end to end relationship with one another away from the tailgate. The casing is removeably disposed in the tailgate and receives the ramp unit. A retaining mechanism is coupled to the tailgate and is moveable between a locked position and an unlocked position.

### CROSS-REFERENCE TO RELATED APPLICATIONS

This application claims the benefit of U.S. Provisional Application No. 62/083,363 filed Nov. 24, 2014. The entire disclosure of the above application is incorporated herein by reference.

### FIELD

The present disclosure relates generally to cargo ramps for use with motor vehicles and, more particularly, to ramp assemblies for use with tailgates to provide access to a cargo area and, still more particularly, to a tailgate assembly equipped with a pair of ramp assemblies integrated within the tailgate.

### BACKGROUND

This section provides background information related to the present disclosure which is not necessarily prior art.

As is well known, many motor vehicles such as, for example, pickup trucks and sport utility vehicles include a cargo carrying section, commonly referred to as the cargo bed, that is configured to be located at the rear of the vehicle. Access to the cargo bed is typically provided by a closure member, such as a tailgate, which most often folds down when opened into a position substantially coplanar with the floor of the cargo bed. Since the cargo bed is elevated above the ground, it is known to use ramps to assist in loading and unloading cargo.

Some cargo ramps are configured to be mounted on the existing tailgate such as, for example, those shown in U.S. Pat. Nos. 3,642,156, 4,900,217 and 5,803,523. As an alternative, some ramp systems are configured to replace the tailgate such as, for example, those shown in U.S. Pat. Nos. 5,244,335, 5,273,335 and 6,913,305. More recently, tailgate assemblies have been developed which are configured to integrate the cargo ramps directly into the tailgate such as is disclosed, for example, in U.S. Pat. No. 8,511,734.

While such conventional ramp systems and tailgate assemblies appear to function satisfactorily for providing access to the cargo bed, a need exists to continue development of advanced tailgate ramp systems capable of reducing weight, improving functionality, and providing simpler operation.

### SUMMARY

This section provides a general summary of the disclosure and is not a comprehensive disclosure of its full scope or all of its aspects, objectives and features.

It is an aspect of the present disclosure to provide a tailgate assembly having a tailgate defining a pair of laterally-spaced internal ramp chambers and a pair of ramp assemblies, each of the ramp assemblies being removeably installed within a corresponding one of the ramp chambers.

It is another aspect of the present disclosure to provide each of the ramp assemblies with a telescopic ramp unit having a plurality of ramp panels configured in a nested arrangement for movement between a non-deployed or retracted position and a deployed or extended position. Each ramp assembly further includes a ramp casing within which the ramp unit is installed. The ramp casing is configured to be removeably installed within the ramp chamber of the tailgate.

It is still a further aspect of the present disclosure to provide the tailgate assembly with a hinged tailgate cover plate operable in a closed position to enclose the ramp assemblies within the tailgate and in an open position to allow access to the ramp assemblies for subsequent movement of the ramp units between their retracted and extended positions.

It is yet another aspect of the present disclosure to provide a linkage mechanism for interconnecting a first panel of each telescopic ramp unit to facilitate common movement between the retracted and extended positions and provide a pinned connection to accommodate differing terrain upon extension and contact with the ground.

Another aspect of the present disclosure provides a central retaining plate capable of releaseably securing both ramp assemblies within the ramp chambers of the tailgate.

In accordance with these and other objects and features, the present disclosure is directed to a tailgate assembly for providing access to a cargo bed of an automotive vehicle, the tailgate assembly comprising: a tailgate defining a compartment; a cover plate connected to the tailgate and moveable between a closed position for closing the compartment and an open position for opening the compartment; a ramp assembly removeably installed with the compartment, the ramp assembly including a ramp unit and casing, the ramp unit including a plurality of panels extending in telescoping relationship with one another and slideably moveable between a collapsed position and a lengthened position, wherein the panels are disposed in overlying relationship with one another inside the compartment of the tailgate in the collapsed position, and wherein the panels extend in generally end to end relationship with one another away from the tailgate in the lengthened position to provide a surface for accessing the cargo bed of the automotive vehicle, the casing being removeably disposed in the compartment of the tailgate and retaining the ramp unit for movement of the panels between the collapsed and lengthened positions; and a retaining mechanism coupled to the tailgate and moveable between a locked position and an unlocked position, wherein the retaining mechanism overlies the casing in the locked position for preventing removal of the ramp assembly from the compartment of the tailgate, and wherein the retaining mechanism is spaced from the housing in the unlocked position for allowing the ramp assembly to be removed from the compartment of the tailgate.

In accordance with the present disclosure, a tailgate assembly is providing for accessing to a cargo bed of an automotive vehicle. The tailgate assembly includes a tailgate and a ramp assembly having a casing and a multi-panel ramp unit. The ramp unit includes a plurality of panels that extend in telescoping relationship with one another and are slideably moveable between a collapsed position with the panels in overlying relationship with one another inside the tailgate, and a lengthened position with the panels extending in generally end to end relationship with one another away from the tailgate. The casing is removeably disposed in the tailgate and receives the ramp unit. A retaining mechanism is coupled to the tailgate and is moveable between a locked position and an unlocked position. In the locked position, the retaining mechanism overlies the casing for preventing removal of the ramp assembly from the tailgate. In the unlocked position, the retaining mechanism is spaced from the casing for allowing the ramp assembly to be removed from the tailgate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Other advantages of the present disclosure will be readily appreciated, as the same becomes better understood by reference to the following detailed description when considered in connection with the accompanying drawings wherein:

FIG. 1 is an environmental view of an exemplary motor vehicle having a cargo bed and a tailgate assembly constructed in accordance with the present disclosure shown in a latched and closed position;

FIG. 2 is an environmental view of the tailgate assembly of FIG. 1 showing its hinged cover plate in an open position;

FIG. 3 is generally similar to FIG. 1 but illustrates the tailgate assembly released and pivoted to an open position to provide access to the cargo bed with its hinged cover plate in a closed position;

FIG. 4 is an enlarged partial view similar to FIG. 3 but now showing the hinged cover plate in its open position;

FIGS. 5 and 6 illustrate a pair of ramp assemblies installed with the tailgate of the tailgate assembly, with the ramp unit of each ramp assembly deployed to its extended position;

FIG. 7 illustrates a linkage mechanism provided for interconnecting a first plank section of each ramp unit;

FIG. 8 is a side view of the motor vehicle illustrating the ramp units of each ramp assembly in its deployed position;

FIG. 9 is generally similar to FIG. 6 but illustrates one of the ramp units in its non-deployed position and the other one of the ramp units in its deployed position;

FIG. 10 is an enlarged perspective view of the first and second plank sections of one of the ramp units;

FIG. 11 illustrates one of the ramp assemblies with its ramp unit in a fully deployed position.

FIG. 12 is a front sectional view of one of the ramp units in its non-deployed position and illustrating the nested configuration of the plank sections.

FIG. 13 is similar to FIG. 13 but further illustrates a first or front stop blocks fixed to the plank sections of the ramp unit;

FIG. 14 is a perspective view, partially cutaway, illustrating engagement of stop blocks associated with adjacent plank sections for limiting telescopic extension therebetween;

FIG. 15 is a perspective view of the tailgate assembly with the cover plate open and illustrating the pair of ramp assemblies installed in the ramp chambers of the tailgate with each ramp unit in its non-deployed position;

FIG. 16 is a perspective view of the tailgate assembly with an interior body panel section removed to better illustrate the location of the ramp assemblies within the tailgate;

FIG. 17 is a perspective view of one of the ramp assemblies removed from the tailgate assembly;

FIG. 18 is a bottom perspective view of the ramp assembly;

FIG. 19 is a partial sectional view illustrating the nested configuration of the plank sections associated with the ramp unit;

FIG. 20 is a partial perspective view of the ramp unit;

FIG. 21 is a side sectional view of the ramp assembly illustrating angular movement of a last or rear plank section relative to the casing;

FIG. 22 is an enlarged partial view of FIG. 21;

FIG. 23 is a partial perspective view of the tailgate assembly illustrating a retaining mechanism in a locked state for releaseably mounting both ramp assemblies within the tailgate;

FIG. 24 is a perspective view of the tailgate assembly with the retaining mechanism in an unlocked state to permit removal of the ramp assemblies from the tailgate;

FIGS. 25 and 26 further illustrate operation of the retaining mechanism;

FIG. 27 illustrates a ramp assembly equipped with a ramp unit constructed in accordance with an alternative embodiment of the present disclosure; and

FIG. 28 is a sectional view of the ramp unit shown in FIG. 27.

Corresponding reference numerals indicate corresponding parts throughout the several views of the drawings.

### DETAILED DESCRIPTION

In general, the present disclosure relates to a ramp assembly adapted to be installed within an internal space or chamber of a tailgate. Additionally, the present disclosure relates to a tailgate assembly configured to include a tailgate defining a pair of internal chambers, and a pair of laterally-spaced ramp assemblies installed in the chambers. Each ramp assembly can be removed from the tailgate for cleaning and/or storage. Additionally, each ramp assembly includes a casing and a multi-plank ramp unit installed in the casing. The ramp unit includes a plurality of nested plank sections that can move telescopically between a non-deployed (“retracted”) position and a deployed (“extended”) position relative to the casing and the tailgate. Specific examples of the tailgate assembly, the tailgate, the ramp assembly, the casing and the ramp unit will be described in greater detail to describe the structure and function of these assemblies and components, but such examples are not intended to be limiting, the scope of the present disclosure being intended to encompass all equivalent structural and functional alternatives.

Referring to the drawings, wherein like numerals indicate corresponding parts throughout the several views, a tailgate ramp apparatus, hereafter referred to as a tailgate assembly 20, is generally shown for providing access to a cargo bed 22 of an automotive vehicle 24, generally indicated as a pickup truck.

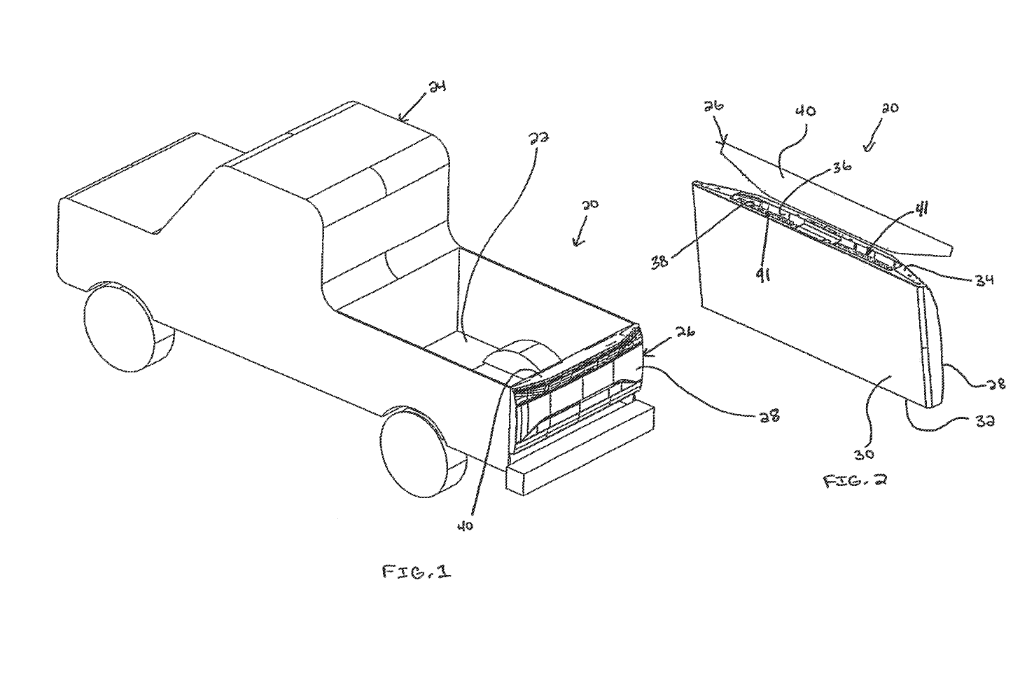

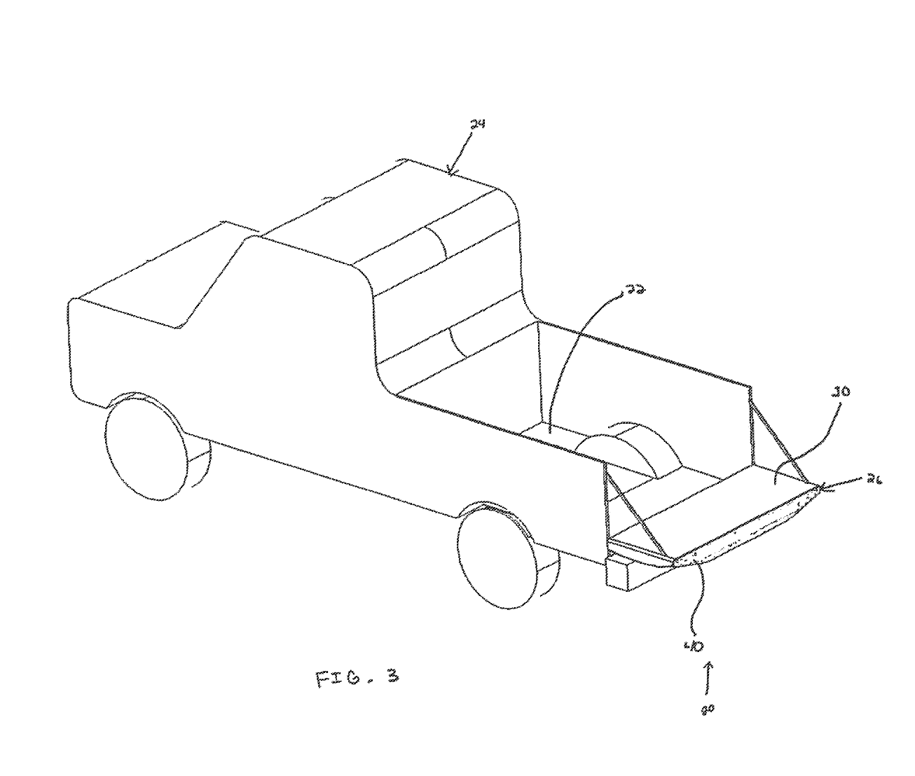

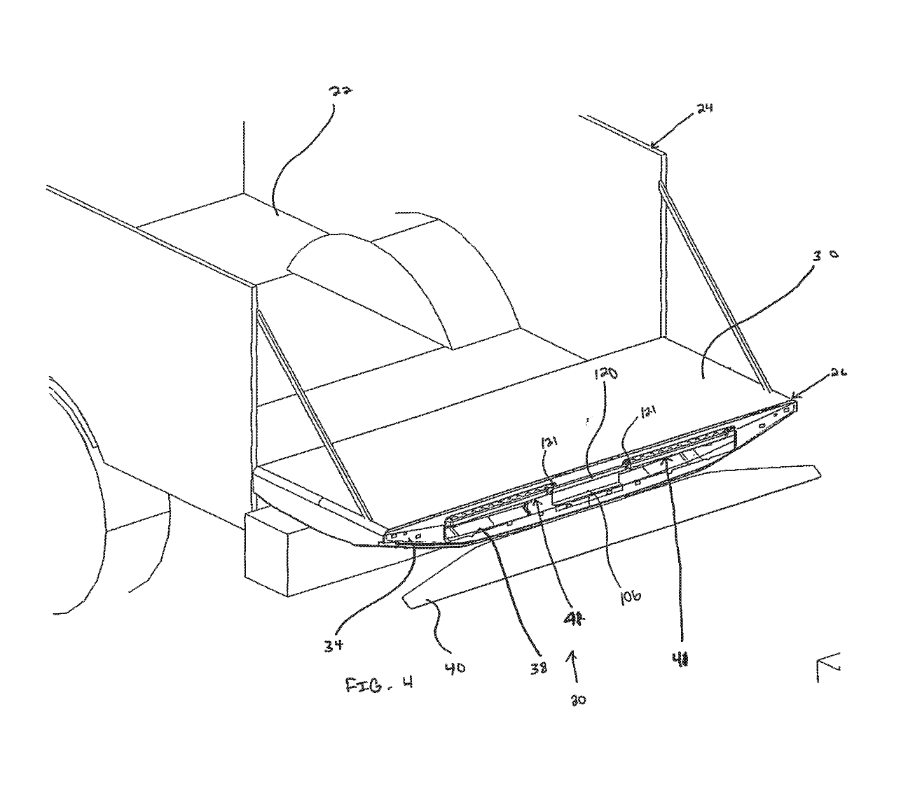

As best presented in FIGS. 1-4, the tailgate assembly 20 includes a tailgate 26, generally indicated, that has a front face 28, a rear face 30, a bottom face 32 and a top face 34 and which defines an internal compartment 36 therebetween. The compartment 36 defines a pair of laterally-spaced mounting chamber 37. As is conventional, tailgate 26 is adapted to pivot between a closed position (FIG. 1) and an open position (FIG. 3) relative to cargo bed 22. The top face 34 defines a mouth 38 that extends into and communicates with the compartment 36. A cover plate or lid 40 is pivotably connected (i.e. hinged) to the front face 28 adjacent to the top face 34 for pivoting between a closed position for enclosing the mouth 38 and an open position for providing access to the mouth 38. Further, a hinge-type connecting mechanism (not shown) is connected to the rear face 30 adjacent to the bottom face 32 and rotatably connects the tailgate 26 with the cargo bed 22 of the automotive vehicle 24. The connecting mechanism permits rotation of tailgate 26 between its closed position closing the bed 22, and its open position with the back wall of the tailgate 26 extending generally coplanar with the bed 22.

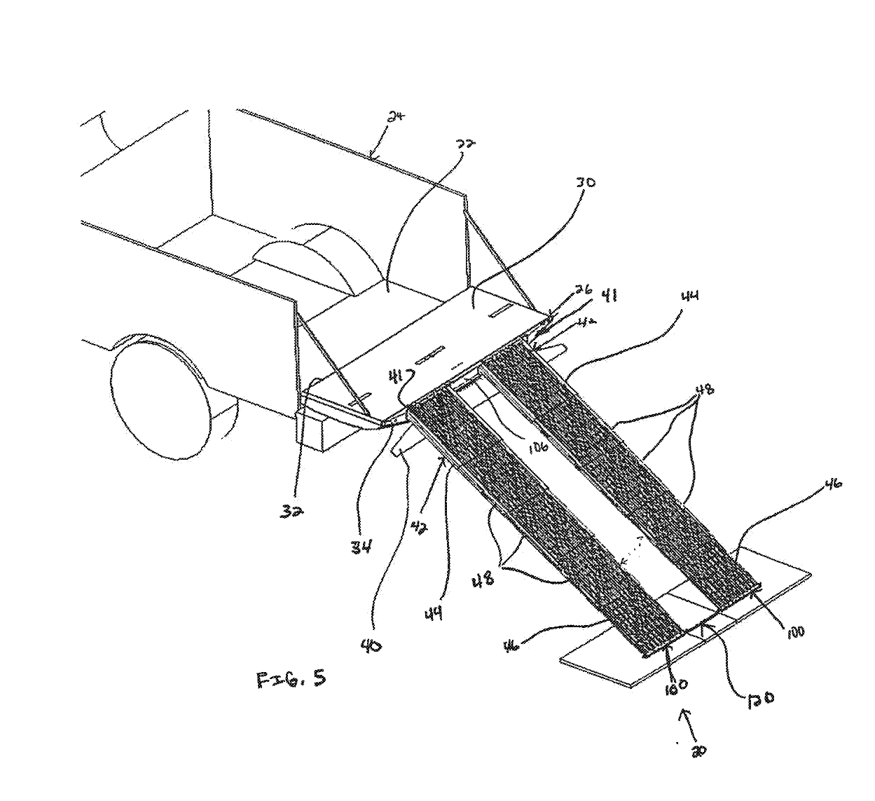

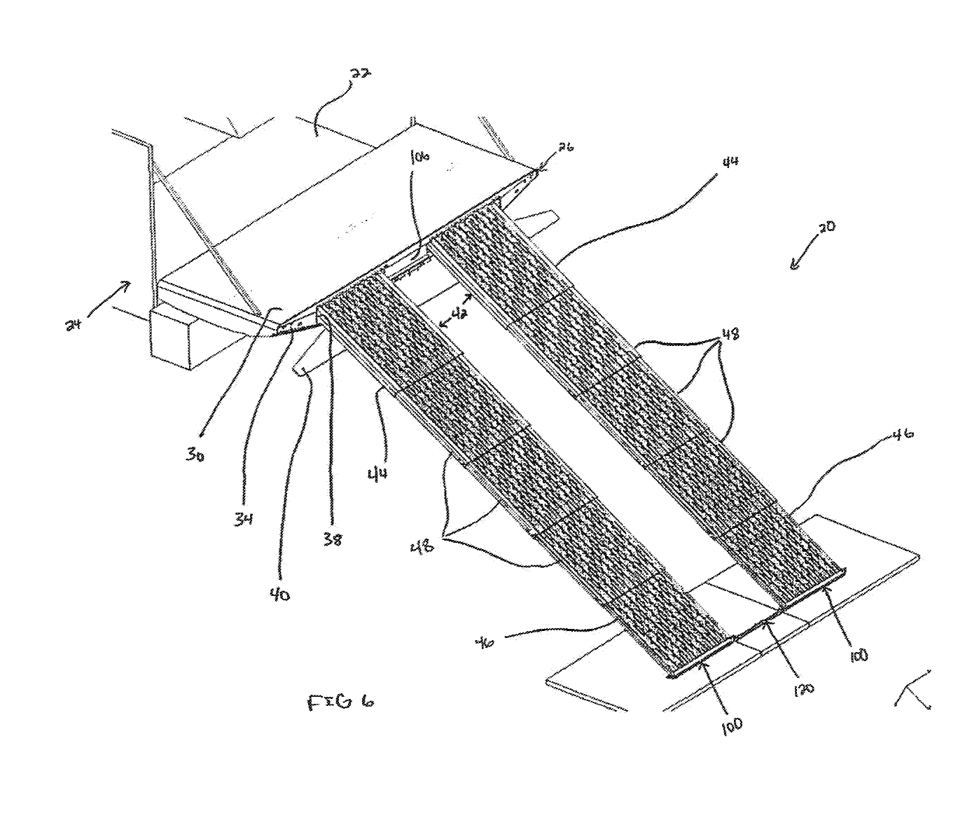

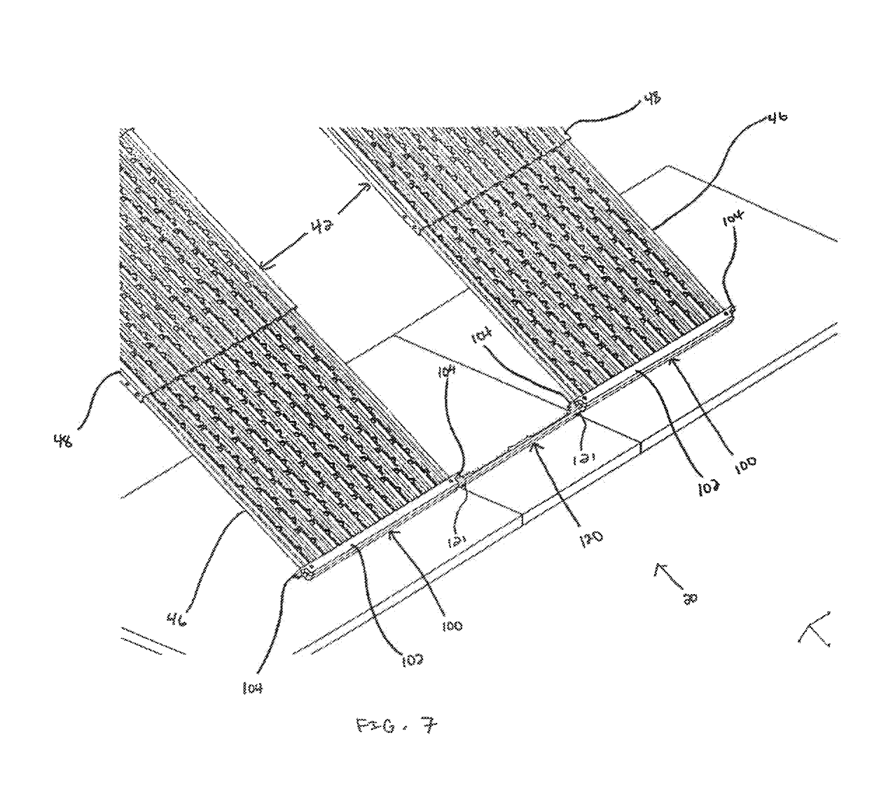

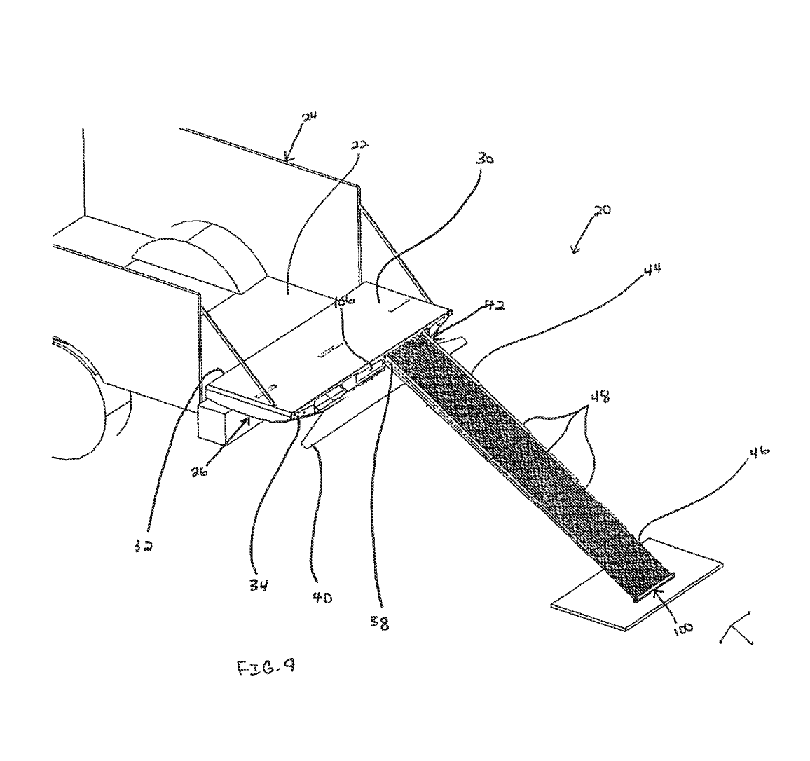

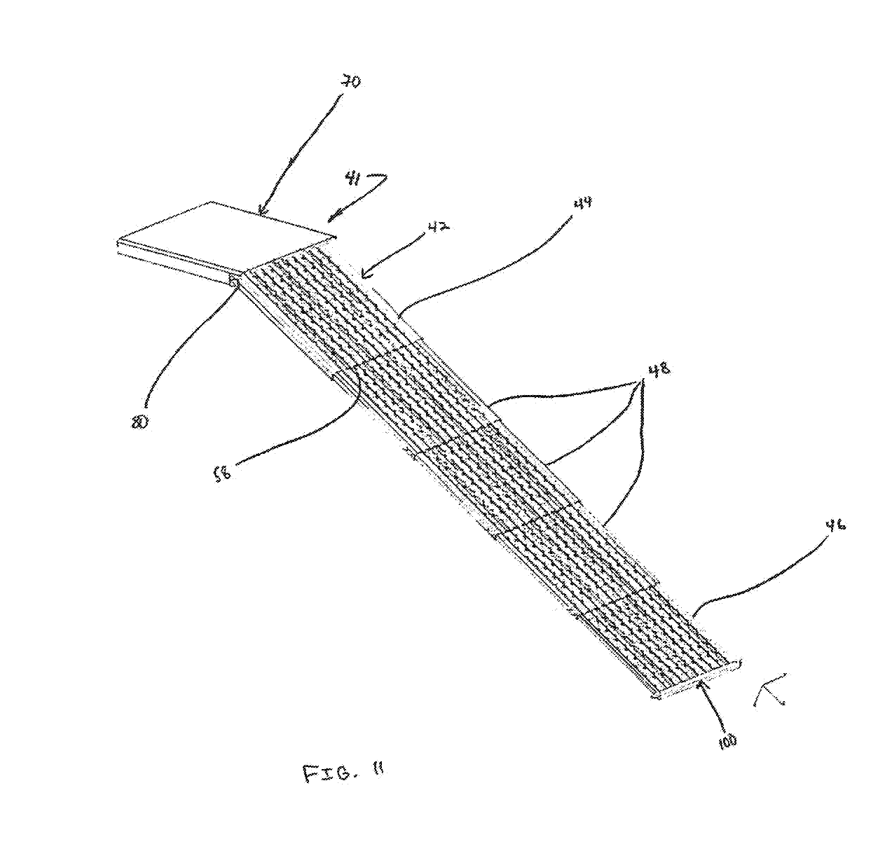

Referring primarily to FIGS. 4-11, the tailgate assembly 20 is shown to include a pair of ramp assemblies 41 which are aligned in spaced and parallel relationship with one another. There could alternatively be more or only one ramp assembly 41 without departing from the scope of the subject disclosure. Each ramp assembly 41 is configured to be removeably installed in a corresponding one of mounting chambers 37. The ramp assemblies 41 each include a casing 70 and a ramp unit 42 having a plurality of interconnected plank sections or panels 44, 46, 48 that are arranged in a nested or “telescoping” relationship with one another. As will be detailed, the ramp unit 42 is moveably disposed within casing 70. In particular, the panels 44, 46, 48 are slideable between a retracted or collapsed position and an extended or lengthened position relative to casing 70. The collapsed position is defined by the panels 44, 46, 48 being disposed in an overlying relationship with one another inside casing 70. Further, the lengthened position is defined by the panels 44, 46, 48 extended in generally end-to-end relationship with one another away from casing 70. When the ramp assemblies 41 are installed in chambers 37, ramp units 42 can be retracted to a non-deployed state so as to be completely disposed within compartment 36 to permit closure of cover plate 40. Additionally, with cover plate 40 opened and tailgate 26 lowered, ramp units 42 can be extended to a deployed state so as to provide a continuous ramp structure extending between the ground and tailgate 26 to permit loading/unloading of cargo bed 22. The gap between the adjacent ramp units 42 is, in a non-limiting example, approximately 300 millimeters to advantageously provide for a large enough space therebetween for a latch and handle assembly of the tailgate 26 to be disposed. The gap could extend to other lengths without departing from the scope of the subject disclosure.

The plurality of panels 44, 46, 48 associated with the ramp unit 42 include an inner or rear panel 44, an outer or front panel 46, and at least one intermediate panel 48 disposed between the rear and front panels 44, 46. In the example embodiment shown, there are three intermediate panels 48, however, that there could be any number of intermediate panels 48 to enable the ramp unit 42 to extend to various lengths without departing from the scope of the subject disclosure. Further, the panels 44, 46, 48 may be made of a heat treated high strength steel like austempered 1050 steel 18 gauge. However, other materials such as aluminum or organic polymer materials could be used without departing from the scope of the subject disclosure. Additionally, each panel 44, 46, 48 may, in accordance with non-limiting example be 510 mm long. However, other lengths could be used without departing from the scope of the subject disclosure.

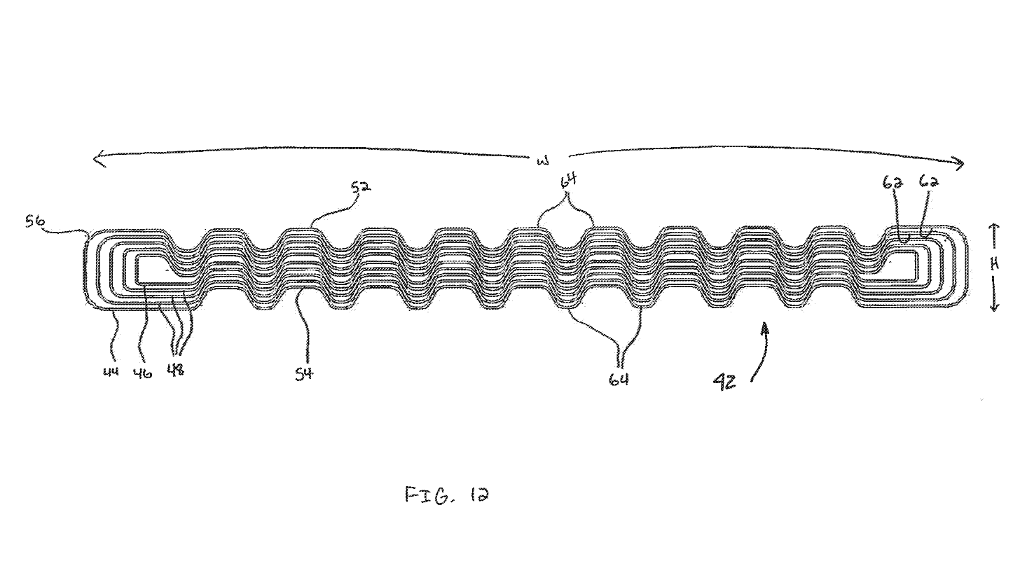

As best illustrated in FIGS. 12-14 and 18, each of the panels 44, 46, 48 has a generally cuboid shape and includes an upper platform 52, a lower platform 54, a pair of sides 56, a forward edge 58 and a rear edge 60. Further, the upper and lower platforms 52, 54 of each panel 44, 46, 48 are spaced from one another to define a channel 62 that extends therethrough between the forward and rear edges 58, 60 for receiving another of the panels 44, 46, 48. The channel 62 of the back panel 44 receives the rearward-most intermediate panel 48 and the channel 62 of the forward-most intermediate panel 48 receives the front panel 46. The panels 44, 46, 48 may be formed through a rolling or stamping process.

As best presented in FIGS. 12-13 and 28, each of the panels 44, 46, 48 defines a width dimension W between the pair of the sides 56, and a height dimension H between the upper and lower platforms 52, 54. The width W and height H of the rear panel 44 are greater than the width W and height H of the intermediate panels 48 for allowing the rear panel 44 to receive the rearward-most intermediate panel 48. Further, the width W and height H of the forward-most intermediate panel 48 is greater than the width W and height H of the front panel 46 for allowing the forward-most intermediate panel 48 to receive the front panel 46. Likewise, the width W and height H of each intermediate panel 48 is greater than the width W and height H of the intermediate panel which is positioned in front of it. In the preferred embodiment, the width W of the back panel 44 may be about 400 mm while the width W of the front panel 46 may be about 350 mm. However, other widths could be used without departing from the scope of the subject disclosure.

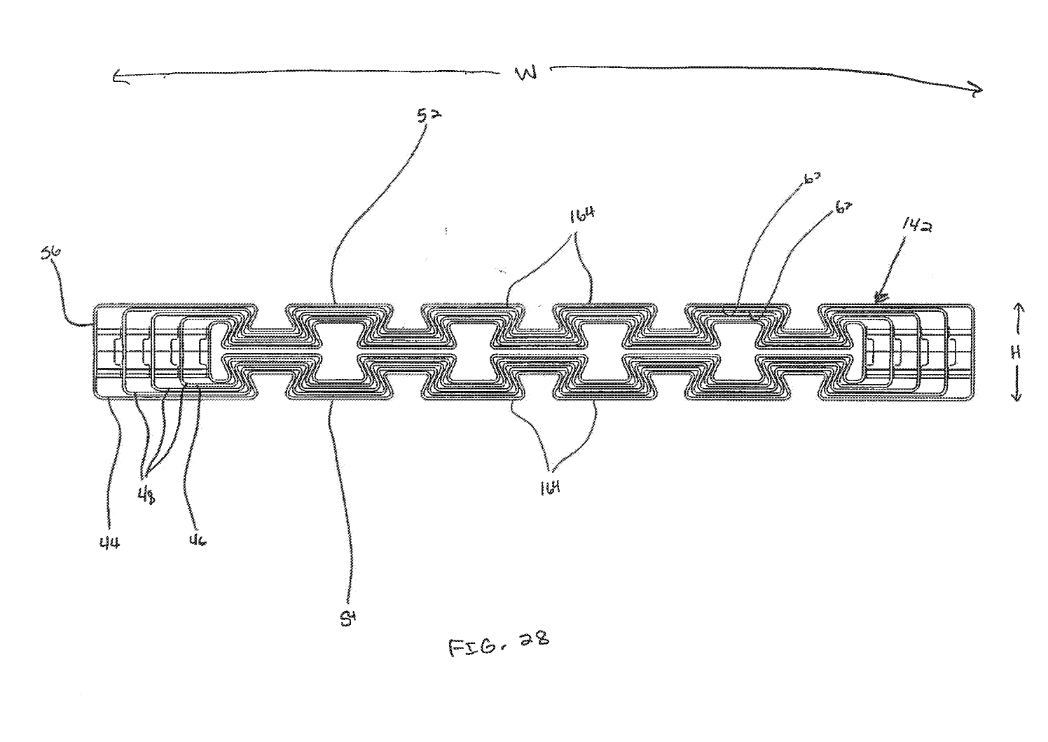

Referring primarily to FIGS. 12-14 and 27-28, the upper and lower platforms 52, 54 of each of the panels 44, 46, 48 are shown to have a plurality of irregularities 64 that extend between the sides 56 of the panels 44, 46, 48. The irregularities 64 provide for a nesting relationship of the panels 44, 46, 48 which overly one another, and further provide for structural rigidity of the panels. In a first embodiment of the ramp units 42, as best presented in FIGS. 12-14, the irregularities 64 of each of the platforms 52, 54 of each of the panels 44, 46, 48 have a wave shaped cross-section. Further, in a second embodiment of the ramp units 142, as shown in FIGS. 27-28, the irregularities 164 of each of the platforms 52, 54 of each of the panels 44, 46, 48 have a dovetail shaped cross-section. However, other shapes of the irregularities could be used without departing from the scope of the subject disclosure.

As best presented in FIG. 10, the upper and lower platforms 52, 54 of each of the panels 44, 46, 48 define a plurality of holes 50 to allow liquids or debris to drain or pass through the panels 44, 46, 48, and also to provide for increased friction on the upper panel 52 for users of the ramp apparatus. Further, a coating (not shown) of a rubber material may be disposed on the upper platform 52 of each of the panels 44, 46, 48, for providing increased friction on the upper platforms 52.

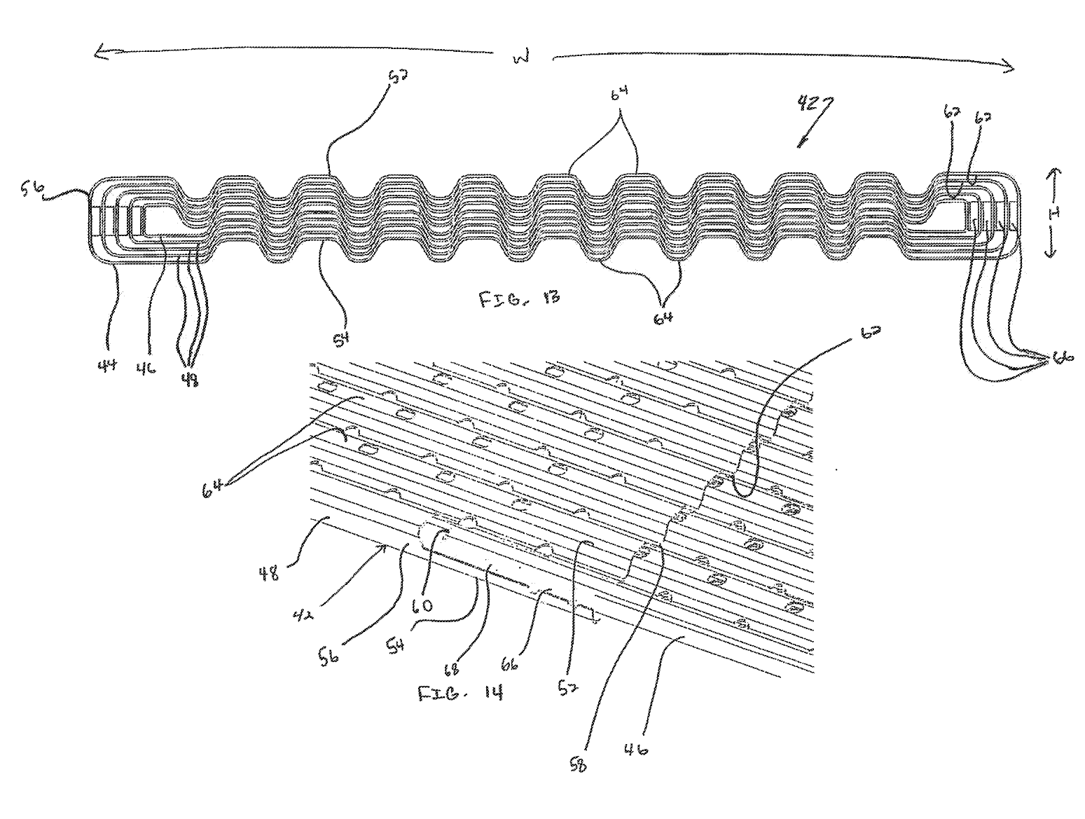

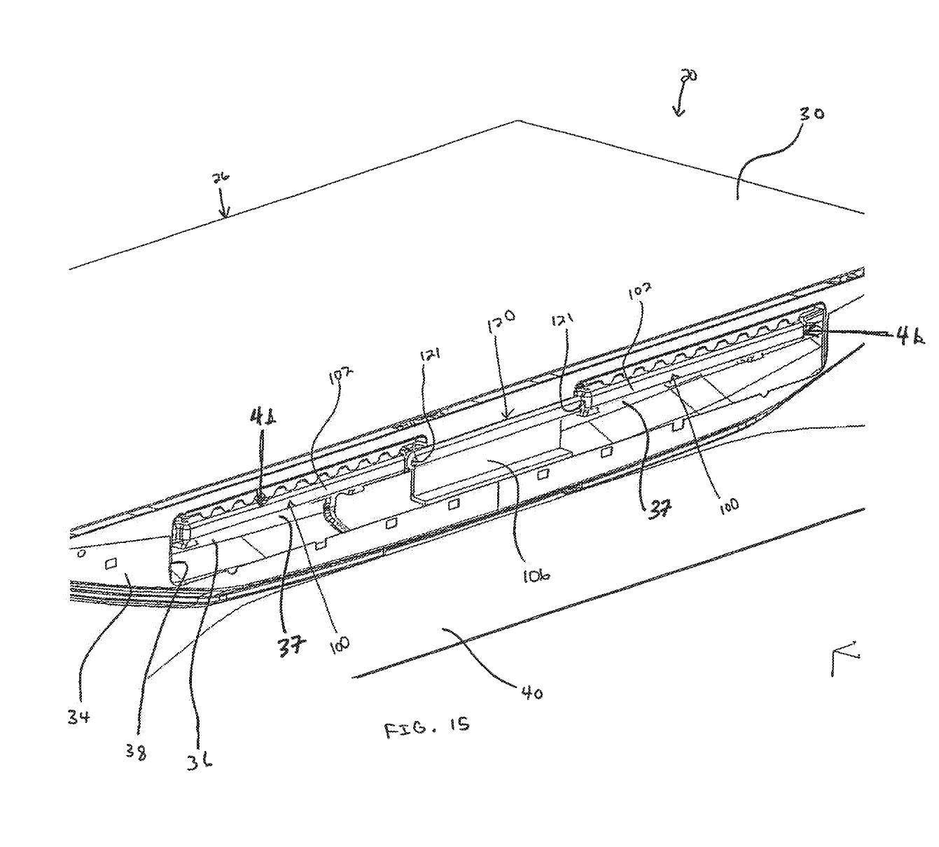

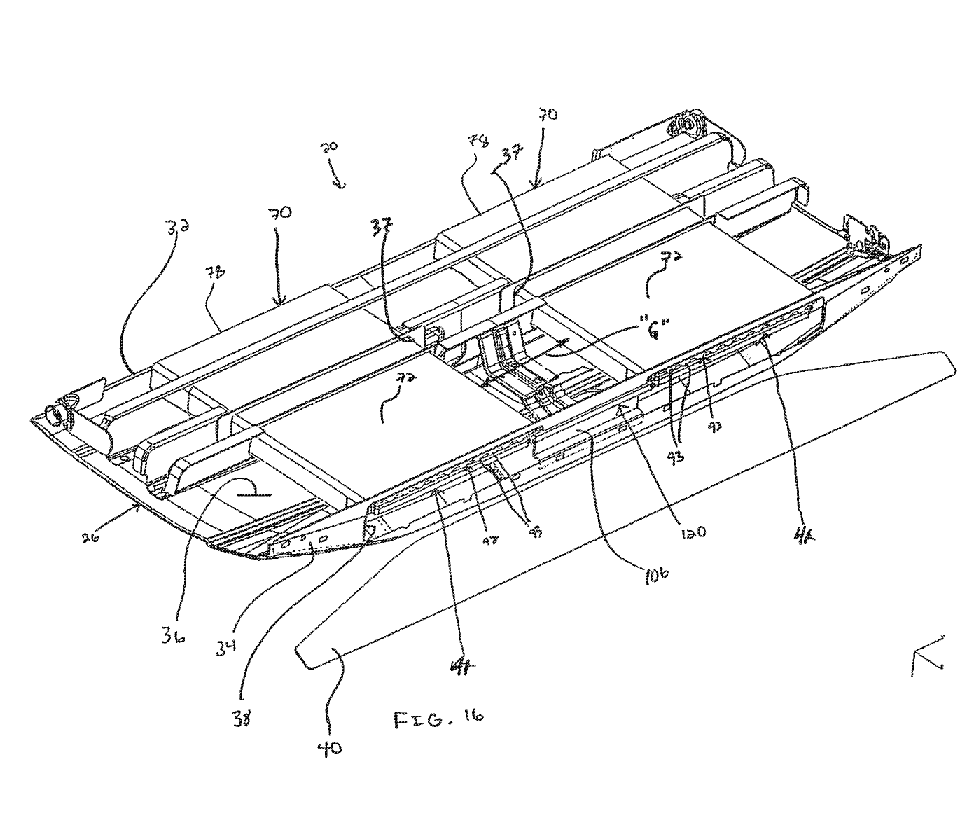

Referring primarily to FIGS. 13-14, each of the plank sections associated with the ramp units 42, 142 is shown to include a front block 66 that engages each of the sides 56 of each of the front and intermediate panels 46, 48 in the channel 62 adjacent to the forward edge 58. Likewise, each of the plank sections of ramp units 42, 142 also include a rear block 68 that engages each of the sides 56 of each of the intermediate and back panels 48, 44 outside of the channel 62. The rear blocks 68 are adapted to engage one of the front blocks 66 during sliding of the panels 44, 46, 48 into the lengthened position to limit sliding movement of the panels 44, 46, 48 relative to one another. In a preferred non-limiting embodiment, the front and rear blocks 66, 68 are positioned such that while the ramp units 42, 142 are in the lengthened position, the panels 44, 46, 48 overlap one another by about 100 millimeter to provide for adequate strength of the panels 44, 46, 48 during use of the ramp apparatus. However, the panels 44, 46, 48 could overlap one another at other lengths without departing from the scope of the subject disclosure. The front and rear blocks 66, 68 are riveted to the panels 44, 46, 48, however, other fastening techniques could be used like screws, bolts or the like without departing from the scope of the subject disclosure.

With the exemplary 100 millimeter overlap of the panels 44, 46, 48 relative to one another, the ramp units 42, 142 extend to approximately 1.8 to 2.1 meters in total length, providing for an angle of between approximately 0 to 35 degrees relative to the ground, which is a satisfactory angle range for common applications of loading cargo into the cargo bed 22. However, the ramp units 42, 142 could be positioned at other angles without departing from the scope of the subject disclosure.

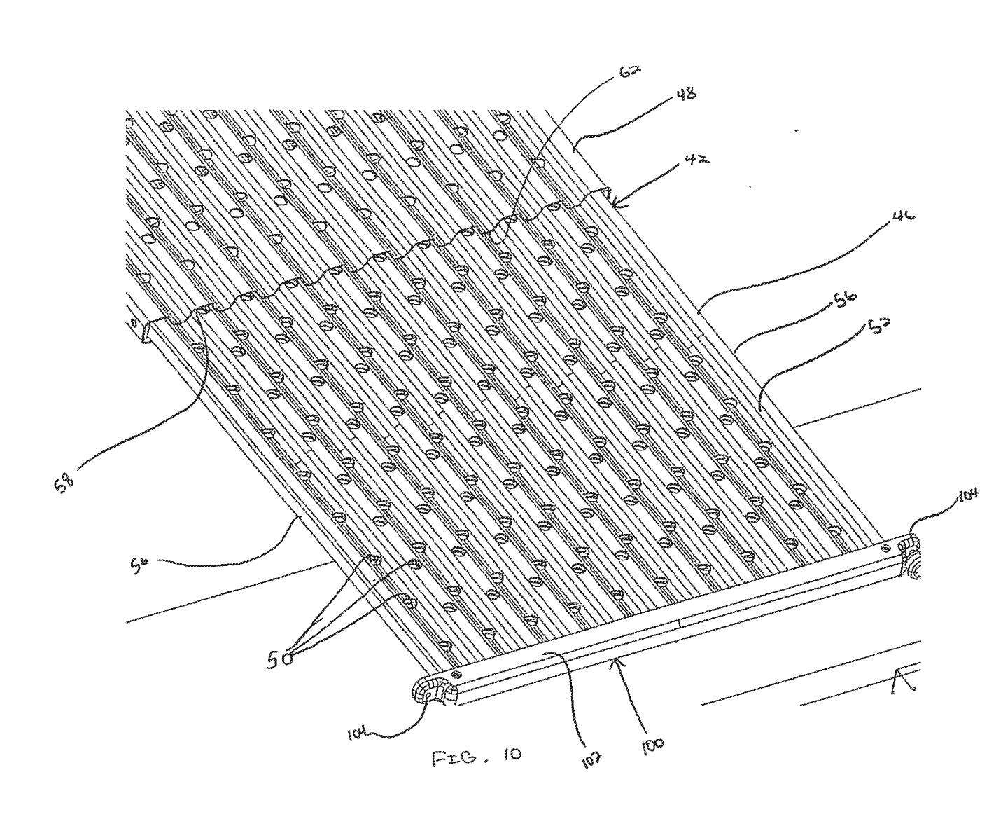

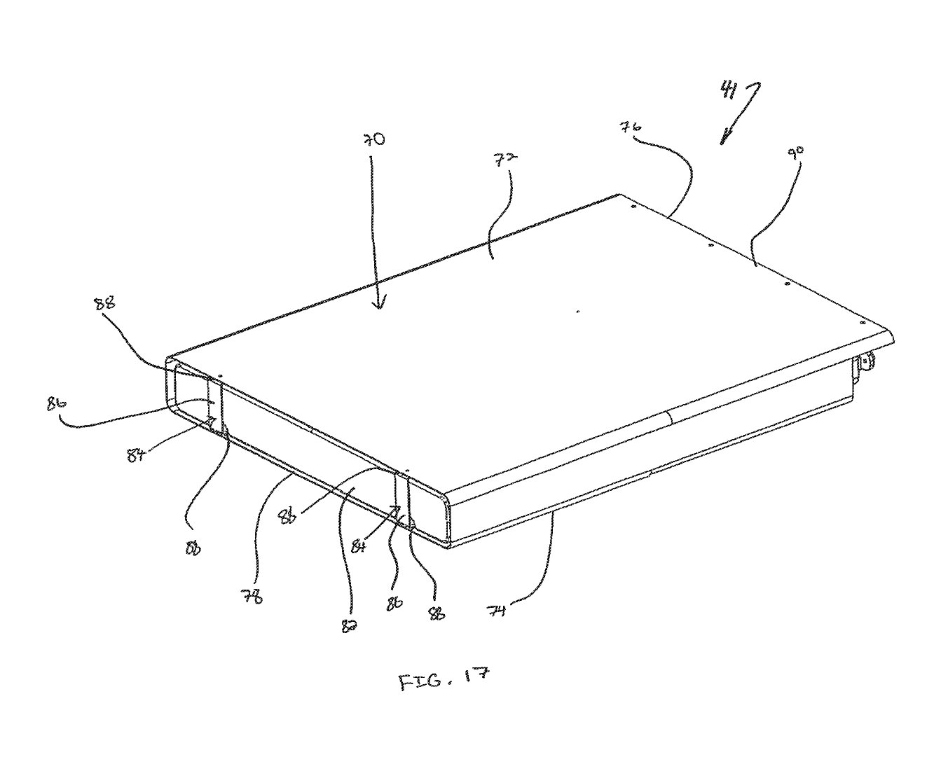

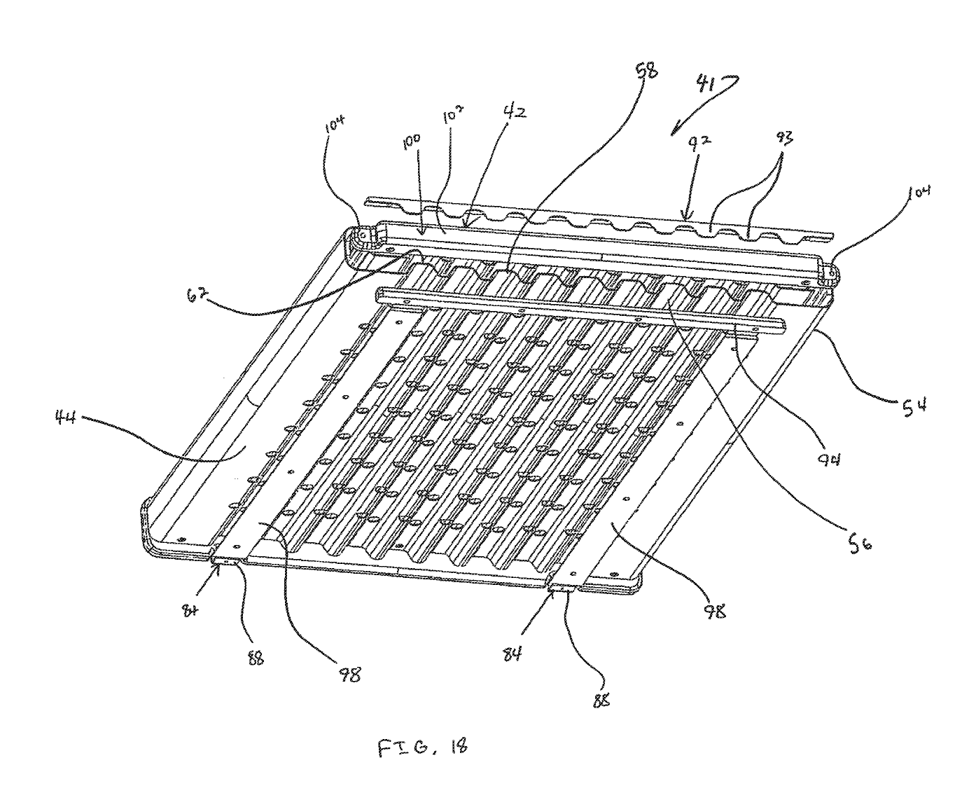

As best presented in FIGS. 16-17, the ramp casings 70 are each removeably disposed in one of the pair of laterally-spaced chambers 37 of compartment 36 within the tailgate 26, and which extend in spaced and parallel relationship with one another. As noted, each ramp assembly 41 includes casing 70 and ramp unit 42. The casings 70 are made of a steel material, however, other materials could be used like aluminum or an organic polymer material without departing from the scope of the subject disclosure. Each casing 70 has a generally cuboid shape, and has an upper wall 72, a lower wall 74, a front periphery 76 and a rear periphery 78. Each casing 70 further defines a passage 80 that extends therethrough between the front and rear peripheries 76, 78 for receiving the panels 44, 46, 48 and containing the panels 44, 46, 48 in the collapsed “nested” position. The front periphery 76 of each of the casings 70 is disposed adjacent to the mouth 38 of the tailgate 26. Each of the casings 70 receives one of the ramp units 42. The casings 70 are not sealed in the tailgate 26 and therefore the casings 70 and ramp units 42, 142 can easily be cleaned while the ramp units 42, 142 are in the lengthened or collapsed positions. Further, as previously mentioned, the gap “G” between the casing 70 is about 300 millimeters to advantageously provide for a large enough space therebetween for a handle and corresponding latching components of the tailgate 26 to be disposed. Specifically, because of the compact configuration of the casing 70 and ramp units 42, 142 and size of the gap “G” between the casings 70, there is a large amount of room in the compartment 36 of the tailgate 26 for latch components such as, for example, mechanical and powered latches, rods, cables or the like to be contained. Thus, the ramp units are adapted to be located on opposite sides of the latch assembly. The latch assembly may include at least one part connected to the handle assembly and operably connected to one or more moveable components configured to move between latched an released positions relative to a locking component mounted to the vehicle body so as to selectively inhibit and permit pivotal movement of the tailgate assembly. Additionally, as best presented in FIG. 9, because of the spaced configuration of the casing 70, either one or both of the ramp units 42, 142 can be in the lengthened position at any given time based on loading needs.

As shown in FIGS. 17 and 21-22, the ramp unit 42 further each include a rearward cap 82 that is disposed about the rear edge 60 of the rear panel 44. Further, each of the casings 70 includes a pair of stoppers 84, generally indicated, that each have a hub 86 and a pair of legs 88 that extend from the hub 86. The legs 88 each engage one of the upper and lower walls 72, 74 inside the passage 80 at the rear periphery 78 and are disposed in spaced and parallel relationship with one another for engaging the rearward cap 82 of the rear panel 44 during sliding of the panels 44, 46, 48 into the collapsed position to limit sliding movement of the rear panel 44 in the casing 70. In the preferred embodiment, the stoppers 84 are made of a steel material and are riveted to the casing 70. However, other materials like aluminum or an organic polymer material could be used without departing from the scope of the subject disclosure. Additionally, other fastening techniques could be used to secure the stoppers 84 to the casing 70 like bolts, screws or the like without departing from the scope of the subject disclosure.

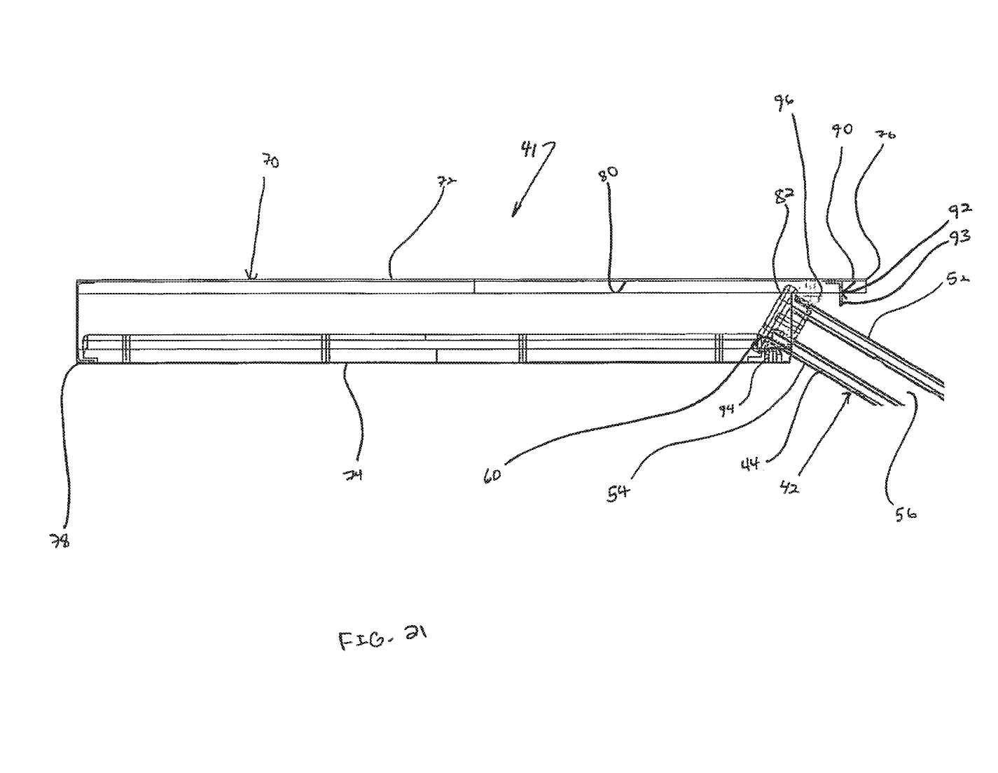

Referring to FIGS. 21-22 and 27, a flange 90 is shown to extend away from and is coplanar with the upper wall 72 of each of the casings 70 at the front periphery 76 of the casing 70. A scraper 92, 192 generally indicated, extends downwardly from the flange 90. The scraper 92, 192 has a plurality of bumps 93, 193 that have a cross-section that is approximately the same as the irregularities 64,164 of the platforms 52, 54. The bumps 93, 193 nest with the irregularities 64,164 of the upper platforms 52 of the rear panel 44 for removing debris from the panels 44, 46, 48 during sliding movement of the panels 44, 46, 48 between the lengthened and collapsed positions. In the enabling embodiments, the scraper 92, 192 is made of a hard plastic material, but other materials could be used such as a rubber, metal or aluminum without departing from the scope of the subject disclosure.

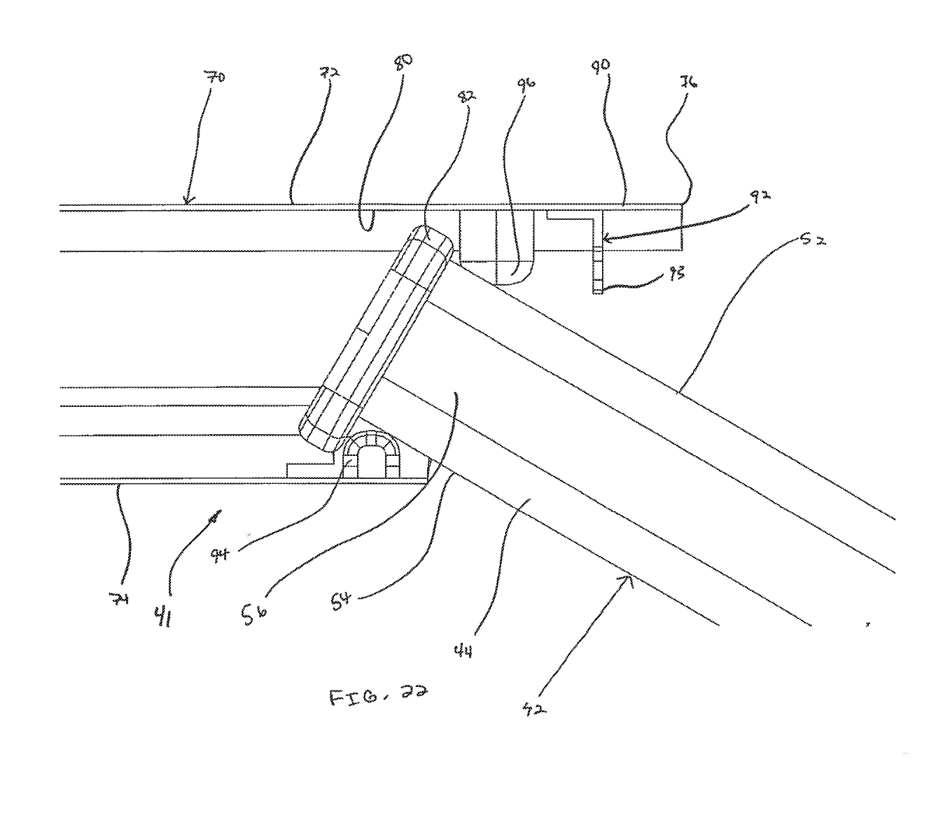

As best presented in FIGS. 21-22, a lower projection 94 extends upwardly from the lower wall 74 of each of the casings 70 adjacent to the front periphery 76 in the passage 80. Further, an upper projection 96 extends downwardly from the upper wall 72 adjacent to the front periphery 76 in the passage 80. The lower and upper projections 94, 96 engage the rearward cap 82 of the rear panel during sliding of the panels 44, 46, 48 into the lengthened position to prevent sliding movement of the rear panel out of the casing 70. The upper projection 96 is spaced from the lower projection 94 in a forward direction toward the front periphery 76, and the lower projection 94 terminates at an end that has a semi-circular cross-section. The spaced relationship of the upper projection 96 relative to the lower projection 94 as well as the semi-circular cross-sectional shape of the end of the lower projection 94 allow the rear panel 44 to pivot about the lower projection 94 during sliding of the panels 44, 46, 48 into the lengthened position. This configuration provides for pivoting of the ramp units 42, 142 at angles between approximately 0 and 35 degrees relative to the casings 70 and the ground, which as previously mentioned, is ideal for common loading applications. It should be appreciated that the lower and upper projections 94, 96 could be spaced at various distances relative to one another and the radius of the semi-circular cross-sectional shape of the end of the lower projection 94 could be varied without departing from the scope of the subject disclosure.

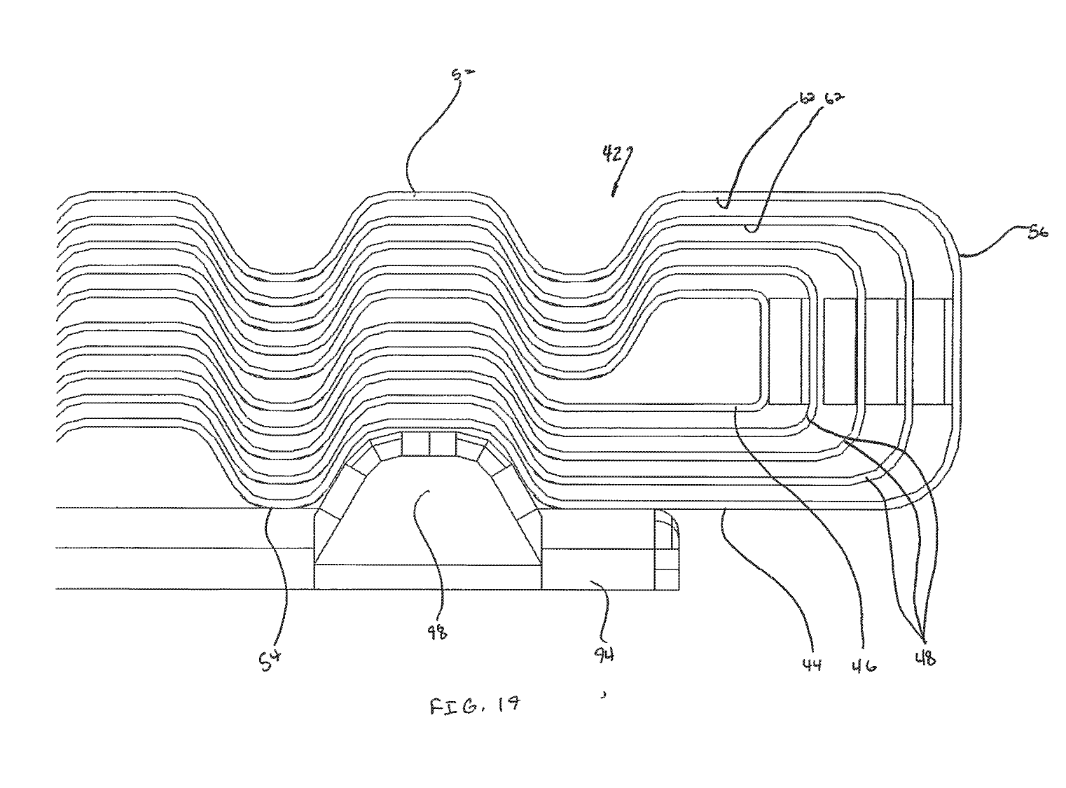

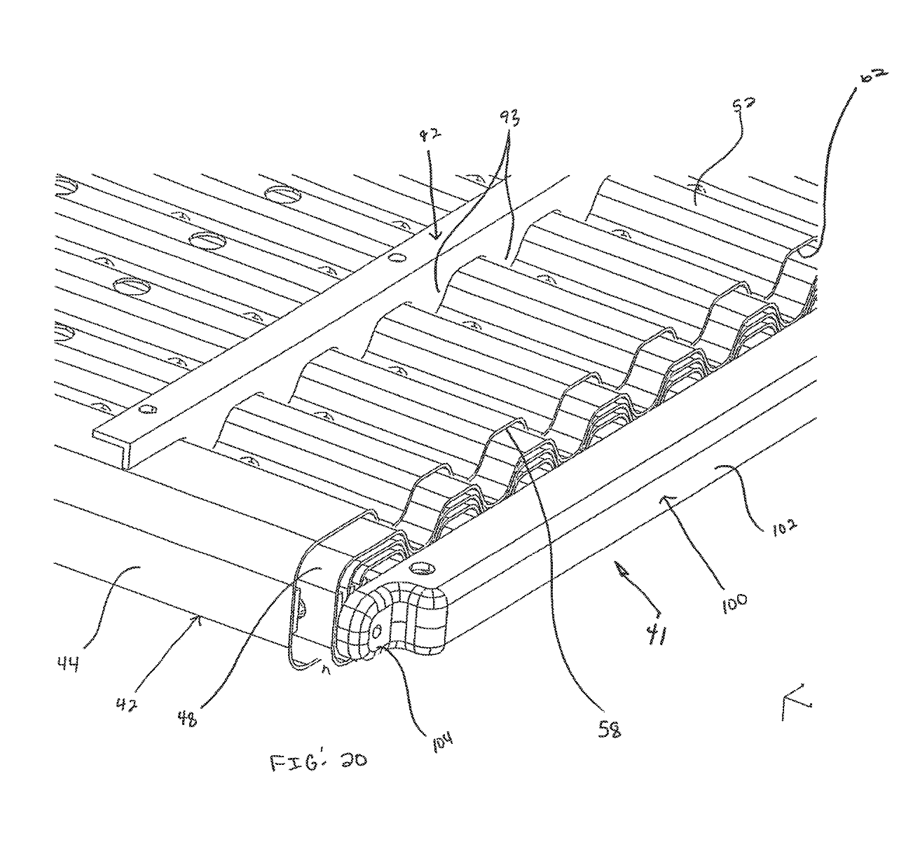

As best seen in FIGS. 18-19, a pair of slide guides 98 engage the lower wall 74 of each of the casings 70. The slide guides 98 extend in spaced and parallel relationship with one another between the front and rear peripheries 76, 78 of the casing 70 inside the passage 80 of the casing 70. The slide guides 98 have a cross-sectional shape that approximately matches the shape of the irregularities of the lower platform 54 of the rear panel 44. The slide guides 98 nest with the irregularities 64, 164 of the lower platform 54 of the rear panel 44 for guiding and maintaining the axial direction of the rear panel 44 during sliding of the panels 44, 46, 48 into the lengthened position. The slide guides 98 are made of an acetyl material but could alternatively be made of other materials such as aluminum, metal, or other organic polymer materials without departing from the scope of the subject disclosure.

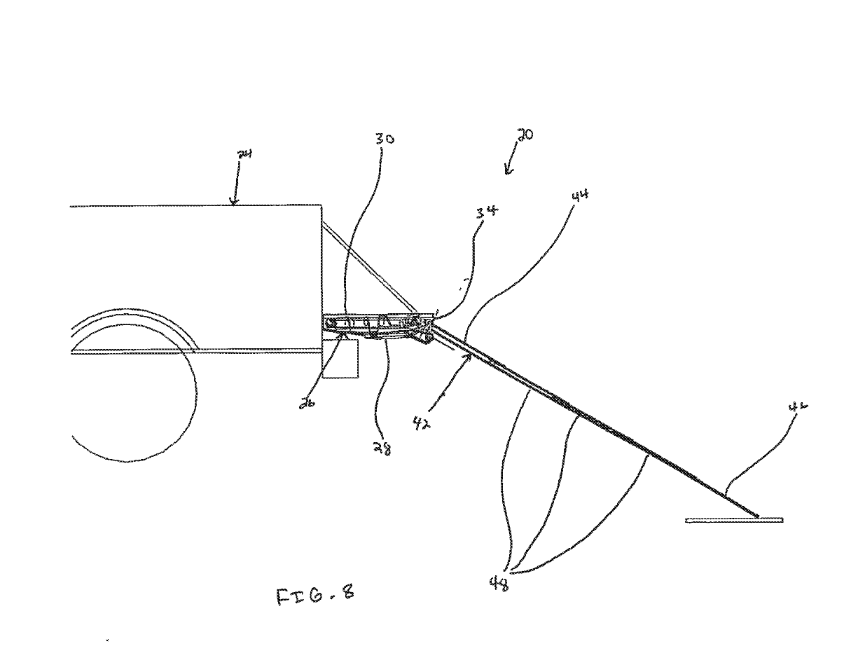

Referring to FIG. 7, each of the ramp units 42 further shown to include a frontward cap 100, generally indicated, that includes a body 102 and a pair of protuberances 104 disposed about the forward edge 58 of the front panel 46. The protuberances 104 each extend outwardly from the body 102 past the sides 56 of the front panel 46. Further, a linkage 120 is pivotally connected with and extends between the flange 90 of each of the frontward caps 100 for connecting the front panels 46 to one another. Since the linkage 120 is pivotally connected to each of the frontward caps 100, the ramp units 42 can advantageously extend from away from the casings 70 at different angles from one another, and therefore can be positioned on the ground at different elevations relative to one another. In the example embodiment shown, a pin joint 121 provides for the pivoting connection of the frontward caps 100. Connecting the front panels 46 with the linkage 120 advantageously also provides for increased safety since it aids in preventing the ramp units 42 from separating from one another during use. Further, the linkage 120 can advantageously be used as a handle by operators for pulling the plank assemblies 42 into the lengthened position. In the preferred embodiment, the frontward caps 100 are made of an aluminum 6061-T6 material, however, other materials could be used like steel or organic polymers without departing from the scope of the subject disclosure.

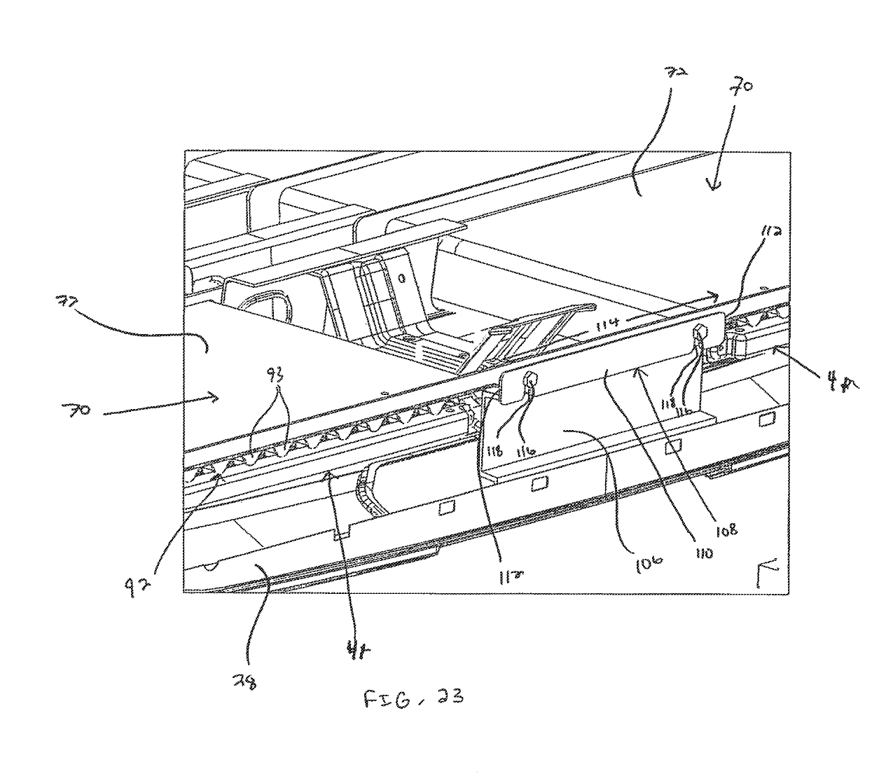

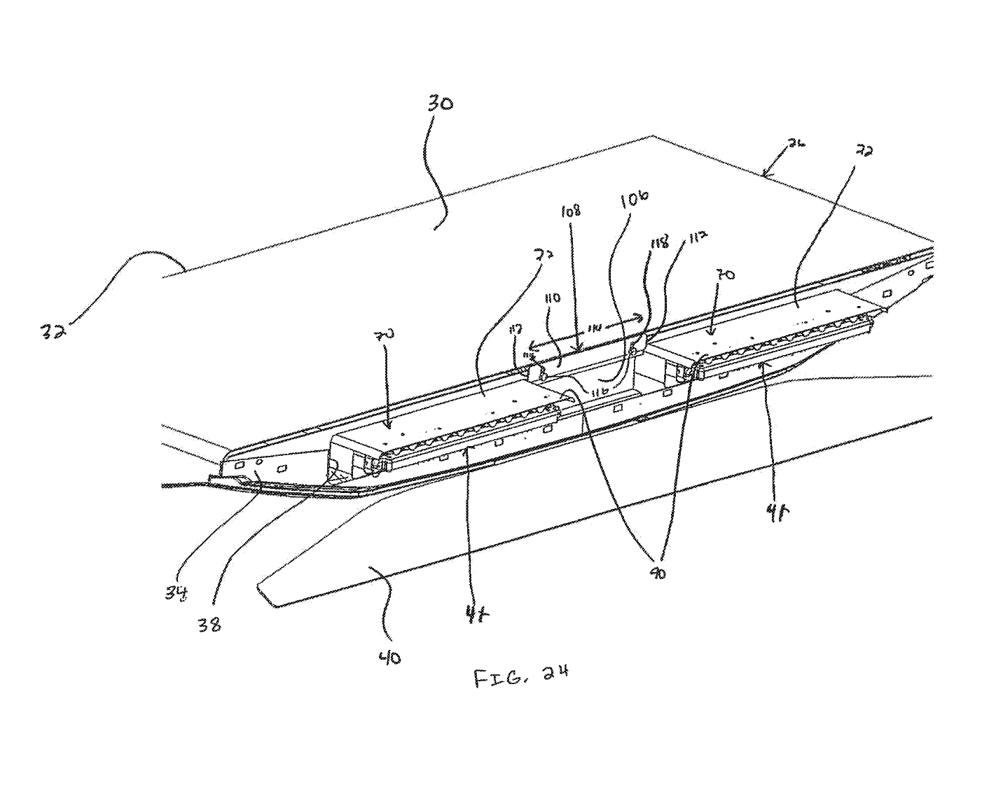

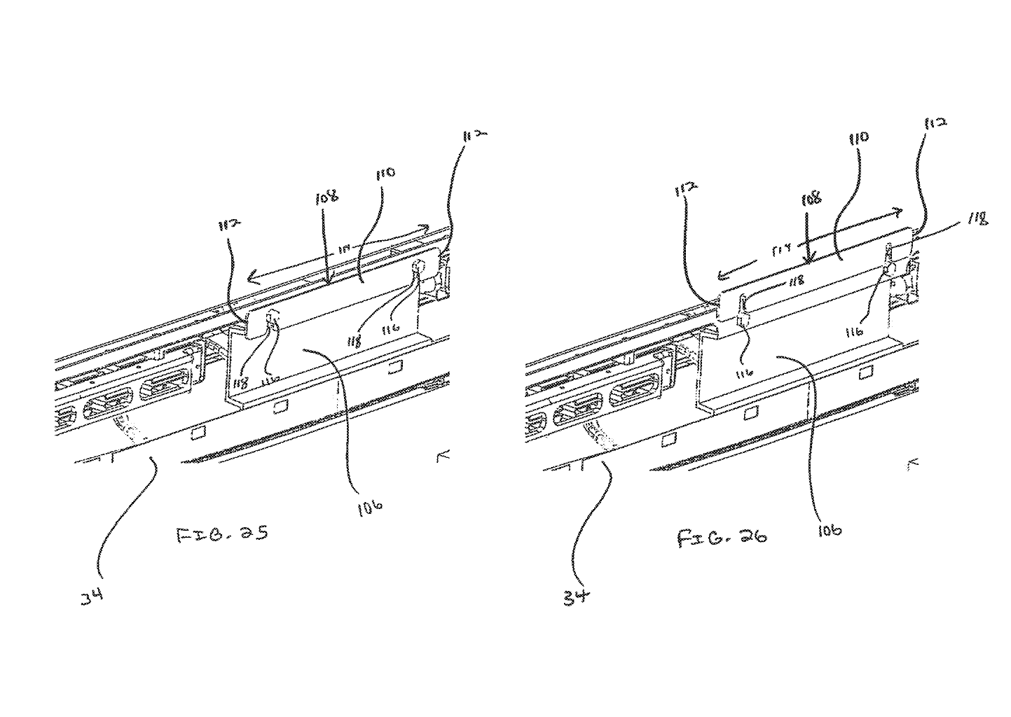

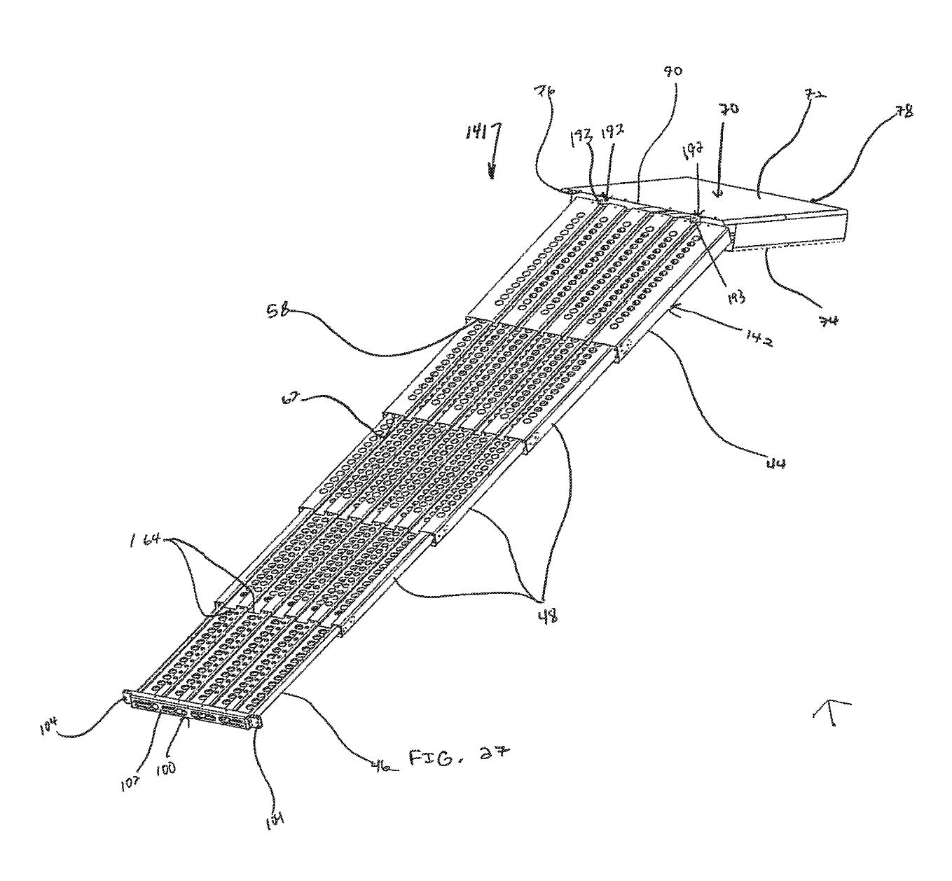

As best presented in FIGS. 23-26, the tailgate 26 further includes a connection member 106 disposed between the pair of casings 70. The connection member 106 extends across the mouth 38 of the tailgate 26 and connects to the top face 34 of the tailgate 26 at locations adjacent to each of the front and rear face 28, 30 of the tailgate 26. A retaining mechanism 108 is coupled to the tailgate 26 and is vertically moveable between a locked position and an unlocked position. The locked position is defined by the retaining mechanism 108 overlying the casings 70 to prevent removal of the ramp assemblies 41 from the compartments 36 of the tailgate 26. Further, the unlocked position is defined by the retaining mechanism 108 being spaced from the casings 70 for allowing the ramp assemblies 41 to be removed from the compartments 36 of the tailgate 26. The retaining mechanism 108 has a generally rectangular shape and extends along an arm 110 between a pair of boundaries 112 and defines a length 114 between the boundaries 112. The retaining mechanism 108 overlies and is slidingly connected with the connection member 106. The boundaries 112 extend horizontally outwardly therefrom and are vertically slideable between the locked position with one of the boundaries 112 of each of the retaining mechanisms 108 overlying one of the flanges 90 of the casings 70, and the unlocked position wherein the boundaries 112 are vertically spaced from the flanges 90 of the casings 70.

A pair of bolts 116 extend into the connection member 106 in spaced relationship with one another adjacent to the back face of the tailgate 26. The retaining mechanism 108 defines a pair of slots 118 that extend parallel to the boundaries 112 in spaced and parallel relationship with one another and receive the bolts 116 for sliding along the bolts 116 to provide for the vertical sliding movement of the retaining mechanism 108.

Example embodiments have been provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular form “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another regions, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teaching of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tailgate assembly for providing access to a cargo bed of an automotive vehicle, comprising:
a tailgate defining a compartment;
a cover plate connected to said tailgate and moveable between a closed position for closing said compartment and an open position for opening said compartment;
a ramp assembly removeably installed within said compartment, said ramp assembly including a ramp unit and a casing, said ramp unit including a plurality of panels extending in telescoping relationship with one another and slideably moveable between a collapsed position and a lengthened position wherein said panels are disposed in overlying relationship with one another inside said compartment of said tailgate in said collapsed position and wherein said panels extend in generally end to end relationship with one another away from said tailgate in said lengthened position to provide a surface for accessing the cargo bed of the automotive vehicle, said casing removeably disposed in said compartment of said tailgate and retaining said ramp unit for movement of said panels between said collapsed and lengthened positions; and
a retaining mechanism coupled to said tailgate and moveable between a locked position and an unlocked position, wherein said retaining mechanism overlies said casing in said locked position for preventing removal of said ramp assembly from said compartment of said tailgate, and wherein said retaining mechanism is spaced from said housing in said unlocked position for allowing said ramp assembly to be removed from said compartment of said tailgate.

2. The tailgate assembly as set forth in claim 1 wherein said compartment in said tailgate defines a pair of internal chambers, and wherein said ramp assembly includes a pair of ramp assemblies with each removeably installed within a corresponding one of said internal chambers such that said casing includes a pair of casings arranged in spaced relationship within said compartment and said ramp unit includes a pair of ramp units each received by one of said pair of casings.

3. The tailgate assembly as set forth in claim 2 further including a linkage pivotally connected with and extending between said pair of ramp units for connecting said ramp units to one another.

4. The tailgate assembly as set forth in claim 3 wherein said retaining mechanism extends along an arm between a pair of boundaries to define a length extending therebetween with each of said boundaries overlying one of said casings when said retaining mechanism is in said locked position.

5. The tailgate assembly as set forth in claim 4 wherein said tailgate further includes a front face and a rear face and a top face extending therebetween, said top face defines a mouth extending into said compartment, wherein a connection member extends across said mouth and is connected with said top face adjacent to each of said front and rear faces of said tailgate, said connection member is disposed between said pair of casings.

6. The tailgate assembly as set forth in claim 5 wherein said retaining mechanism overlies and is slidingly connected with said connection member.

7. The tailgate assembly as set forth in claim 6 wherein a pair of bolts each extend through said connection member and said top face of said tailgate and connect said connection member and said top face of said tailgate to one another, wherein said bolts disposed in spaced and parallel relationship with one another adjacent to said rear face of said tailgate, and wherein said arm of said retaining mechanism defines a pair of slots that extend perpendicularly to said length of said arm in spaced and parallel relationship with one another and slidingly receive said bolts for sliding said retaining mechanism along said bolts to provide for said vertical sliding movement of said retaining mechanism.

8. The tailgate assembly as set forth in claim 1 wherein each of said plurality of panels has an upper platform, a lower platform spaced from said upper platform, a pair of sides, a forward edge and a rear edge, which together define a channel extending therebetween.

9. The tailgate assembly as set forth in claim 8 wherein said plurality of panels include a back panel and a front panel and at least one intermediate panel disposed between said back and front panels.

10. The tailgate assembly as set forth in claim 9 wherein said channel of said back panel receives said at least one intermediate panel and said channel of said intermediate panel receives said front panel.

11. The tailgate assembly as set forth in claim 9 wherein said upper and lower platforms of each of said panels have a plurality of irregularities extending between said sides of said panels for allowing said panels to overly one another in nesting relationship with one another.

12. The tailgate assembly as set forth in claim 11 wherein said irregularities of each of said platforms of said panels have a wave shaped cross-section.

13. The tailgate assembly as set forth in claim 11 wherein said irregularities of each of said platforms of said panels have a dovetail shaped cross-section.

14. The tailgate assembly as set forth in claim 11 further including a scraper having a plurality of bumps each having a cross-section being approximately the same as said irregularities of said platforms of said panels and said bumps nesting with said irregularities of said upper platform of said back panel to remove debris from said back panel during sliding movement of said panels between said extended and said collapsed positions.

15. The tailgate assembly as set forth in claim 9 wherein said at least ramp unit further includes a front block engaging each of said sides of each of said front and intermediate panels in said channel adjacent to said forward edge, and wherein said at least one ramp unit further includes a rear block engaging each of said sides of each of said intermediate and back panels outside of said channel and each engaging one of said front blocks when said ramp unit is in said lengthened position to limit said sliding movement of said panels relative to one another.

16. The tailgate assembly as set forth in claim 9 wherein said tailgate includes a front face and a rear face and a top face extending therebetween, said top face defines a mouth extending into said compartment, said at least one casing has an upper wall and a lower wall and a front periphery and a rear periphery and a passage extending therethrough receiving said ramp units, and wherein said front periphery of said at least one casing is disposed adjacent to said mouth of said tailgate.

17. The tailgate assembly as set forth in claim 16 further including a rearward cap disposed about said rear edge of said back panel, wherein a lower projection extending upwardly from said lower wall of said at least one casing in said passage and an upper projection extending downwardly from said upper wall adjacent to said front periphery in said passage and said lower projection engaging said rearward cap of said rear panel when said ramp unit is in said lengthened position, and wherein said upper projection is spaced from said lower projection toward said front periphery and said lower projection terminates at an end having a semi-circular cross-section for allowing said rear panel to pivot about said lower projection during sliding of said panels between said collapsed and lengthened positions.

18. A tailgate assembly for providing access to a cargo bed of an automotive vehicle, comprising:
a tailgate defining a compartment;
a cover plate connected to said tailgate and moveable between a closed position for closing said compartment and an open position for opening said compartment;
a pair of laterally-spaced ramp assemblies installed within said compartment, each of said ramp assemblies includes a ramp unit and a casing, said ramp unit including a plurality of panels extending in telescoping relationship with one another and slideably moveable between a collapsed position and a lengthened position wherein said panels are disposed in overlying relationship with one another inside said compartment of said tailgate in said collapsed position and wherein said panels extend in generally end to end relationship with one another away from said tailgate in said lengthened position to provide a surface for accessing the cargo bed of the automotive vehicle, said casing being disposed in said compartment of said tailgate and retaining said ramp unit for movement of said panels between said collapsed and lengthened positions; and
a retaining mechanism coupled to said tailgate and moveable between a locked position and an unlocked position, wherein said retaining mechanism overlies said casing of each of said ramp assemblies in said locked position for preventing removal of said ramp assemblies from said compartment of said tailgate, and wherein said retaining mechanism is spaced from said housing in said unlocked position for allowing said ramp assemblies to be removed from said compartment of said tailgate, wherein said ramp assemblies are separated within said chamber by a predetermined dimension defining a gap, wherein said gap is configured to accommodate a handle and a tailgate latch mechanism operable for permitting selective movement of said tailgate assembly between a closed position relative to the cargo bed and an open position relative to the cargo bed.

19. The tailgate assembly as set forth in claim 18 further including a linkage pivotally connected with and extending between each of said ramp units for connecting said ramp units to one another.

20. The tailgate assembly as set forth in claim 19 wherein said tailgate further includes a front face and a rear face and a top face extending therebetween, said top face defines a mouth extending into said compartment, wherein a connection member extends across said mouth and is connected with said top face adjacent to each of said front and rear faces of said tailgate, said connection member is disposed between said pair of casings.
